(19) United States
(12) Patent Application Publication
(10) Pub. No.: US 2025/0119229 A1
(43) Pub. Date: Apr. 10, 2025

(54) Binary Firmware Encryption Via Scrambler/Descrambler Module

(71) Applicant: Micron Technology, Inc., Boise, ID (US)

(72) Inventors: Flavio PACE, Filiano (PZ) (IT); Laura FERRANTE, San Giorgio a Cremano (NA) (IT); Dario BARBIERI, Casamicciola Terme (NA) (IT)

(21) Appl. No.: 18/407,799

(22) Filed: Jan. 9, 2024

Related U.S. Application Data
(60) Provisional application No. 63/479,508, filed on Jan. 11, 2023.

(51) Int. Cl. H04K 1/00

(52) U.S. Cl. CPC H04K 1/00

(57) ABSTRACT

The disclosed embodiments relate to securely delivering firmware to memory devices. In some aspects, the techniques described herein relate to a system including: a firmware generator; a memory device; and an emulation platform, the emulation platform configured to: receive a firmware image from the firmware generator, scramble the firmware image using a scrambler module to obtain a scrambled firmware image, and transmit the scrambled firmware image to the memory device.

### RELATED APPLICATIONS

The present application claims priority to Prov. U.S. Pat. App. Ser. No. 63/479,508 filed Jan. 11, 2023, the entire disclosure of which application is hereby incorporated herein by reference.

### TECHNICAL FIELD

At least some embodiments disclosed herein relate to memory devices in general, and more particularly, but not limited to securing firmware delivery and installation on such devices.

### BACKGROUND

A memory subsystem can include one or more memory devices that store data. The memory devices can be, for example, non-volatile memory devices and volatile memory devices. In general, a host system can utilize a memory subsystem to store data at the memory devices and to retrieve data from the memory devices. The memory system generally includes a controller that executes firmware.

### BRIEF DESCRIPTION OF THE DRAWINGS

The embodiments are illustrated by way of example and not limitation in the figures of the accompanying drawings in which like references indicate similar elements.

FIG. 1 is a block diagram of a system for delivering firmware to memory devices.

FIG. 2 is a block diagram of a sample firmware image.

FIG. 3 is a diagram illustrating different encryption techniques as applied to a firmware image.

FIG. 4 is a swimlane diagram illustrating a method for delivering firmware to memory devices.

FIG. 5 is a flow diagram illustrating a method for generating and securing a firmware image.

FIG. 6 is a flow diagram illustrating a method for scrambling a firmware image.

FIG. 7 is a flow diagram illustrating a method for installing a scrambled firmware image.

FIG. 8 is a block diagram illustrating a memory system according to some embodiments of the disclosure.

FIG. 9 is a block diagram illustrating a computing device showing an example of a client or server device used in the various embodiments of the disclosure.

### DETAILED DESCRIPTION

The example embodiments relate to a system for securing firmware deliveries to memory devices. In brief, a compiled firmware image is transmitted to an emulation platform which executes an emulated memory devices that mirrors a target memory device. Both the emulated memory device and target memory device include a scrambler and descrambler module. The emulation platform scrambles the firmware image and ultimately returns the scrambled firmware image to the memory device. The memory device uses the descrambler to descramble the firmware image and update the current firmware using the descrambled firmware image.

In some aspects, the techniques described herein relate to a system including: a firmware generator; a memory device; and an emulation platform, the emulation platform configured to: receive a firmware image from the firmware generator, scramble the firmware image using a scrambler module to obtain a scrambled firmware image, and transmit the scrambled firmware image to the memory device.

In some aspects, the techniques described herein relate to a system, wherein the memory device is configured to: receive the scrambled firmware image; descramble the scrambled firmware image using a descrambler circuit to obtain a descrambled firmware image; and install the descrambled firmware image.

In some aspects, the techniques described herein relate to a system, wherein the emulation platform is further configured to load an emulated memory device corresponding to the memory device.

In some aspects, the techniques described herein relate to a system, wherein the scrambler module includes an emulated scrambler circuit corresponding to a physical descrambler circuit of the memory device.

In some aspects, the techniques described herein relate to a system, wherein the emulation platform is further configured to validate the scrambled firmware image using an emulated descrambler module.

In some aspects, the techniques described herein relate to a system, wherein the emulation platform is configured to transmit the scrambled firmware image to the memory device by transmitting the scrambled firmware image to an update server.

In some aspects, the techniques described herein relate to a system, wherein the emulation platform is configured to transmit the scrambled firmware image to the memory device by transmitting the scrambled firmware image to the firmware generator.

In some aspects, the techniques described herein relate to a system, wherein the scrambler module includes a low-density parity check (LDPC) scrambler.

In some aspects, the techniques described herein relate to a method including: receiving a firmware image; scrambling the firmware image using an emulated scrambler to generate a scrambled firmware image; and transmitting the scrambled firmware image to at least one memory device.

In some aspects, the techniques described herein relate to a method, wherein scrambling the firmware image using an emulated scrambler includes scrambling the firmware image includes scrambling the firmware image using a low-density parity check (LDPC) scrambler.

In some aspects, the techniques described herein relate to a method, wherein receiving the firmware image includes identifying an identify of the at least one memory device and loading a corresponding emulated memory device that includes the emulated scrambler.

In some aspects, the techniques described herein relate to a method, wherein identifying an identify of the at least one memory device includes extracting an identify of the at least one memory device from the firmware image.

In some aspects, the techniques described herein relate to a method, further including validating the scrambled firmware image by descrambling the scrambled firmware image using an emulated descrambler.

In some aspects, the techniques described herein relate to a method, wherein transmitting the scrambled firmware image to at least one memory device including transmit the scrambled firmware image to the at least one memory device by transmitting the scrambled firmware image to an update server.

In some aspects, the techniques described herein relate to a method, wherein the firmware image includes a binary image, the binary image including one of a password, key, special string, or overlay data.

In some aspects, the techniques described herein relate to a memory device including: a storage area configured for storing firmware images; and a controller configured to: receive a scrambled firmware image, descramble the scrambled firmware image to obtain a descrambled firmware image, install the descrambled firmware image in the storage area.

In some aspects, the techniques described herein relate to a memory device, wherein the controller is configured to descramble the scrambled firmware image by inputting the scrambled firmware image to a descrambler circuit.

In some aspects, the techniques described herein relate to a memory device, wherein the descrambler circuit includes a low-density parity check (LDPC) descrambler.

In some aspects, the techniques described herein relate to a memory device, wherein the controller is further configured to validate the descrambled firmware image prior to installing the descrambled firmware image.

In some aspects, the techniques described herein relate to a memory device, wherein the controller is configured to receive the scrambled firmware image via a firmware update command.

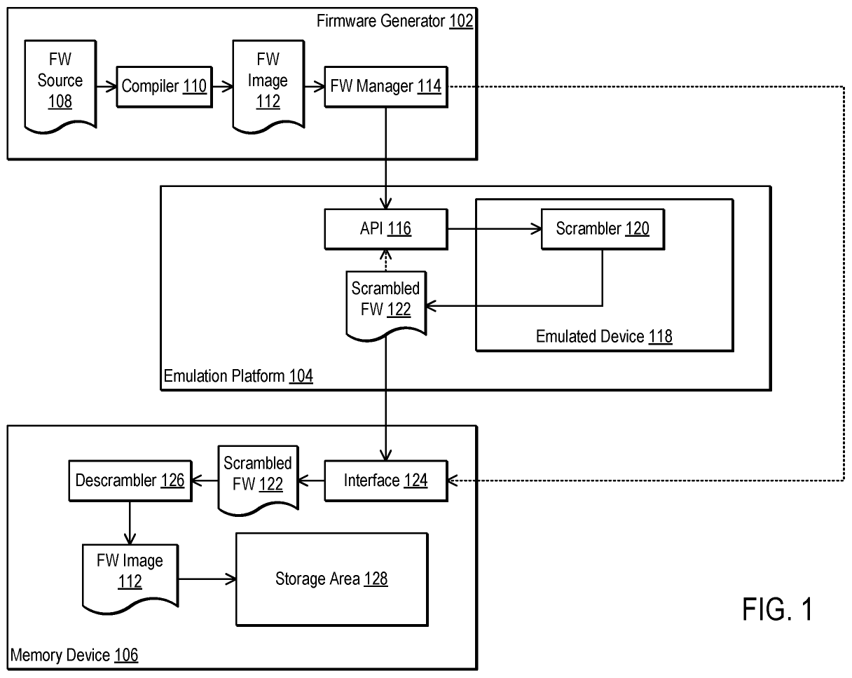

FIG. 1 is a block diagram of a system for delivering firmware to memory devices.

As illustrated, a system includes a firmware generator 102, an emulation platform 104, and a memory device 106. Although a single instance of each device is illustrated the system may include multiple such devices.

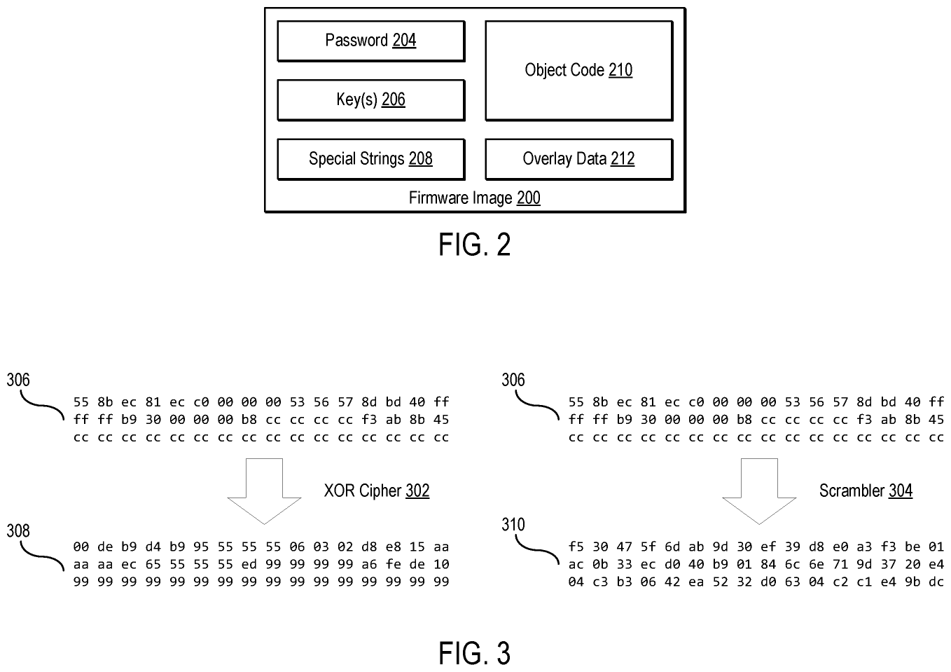

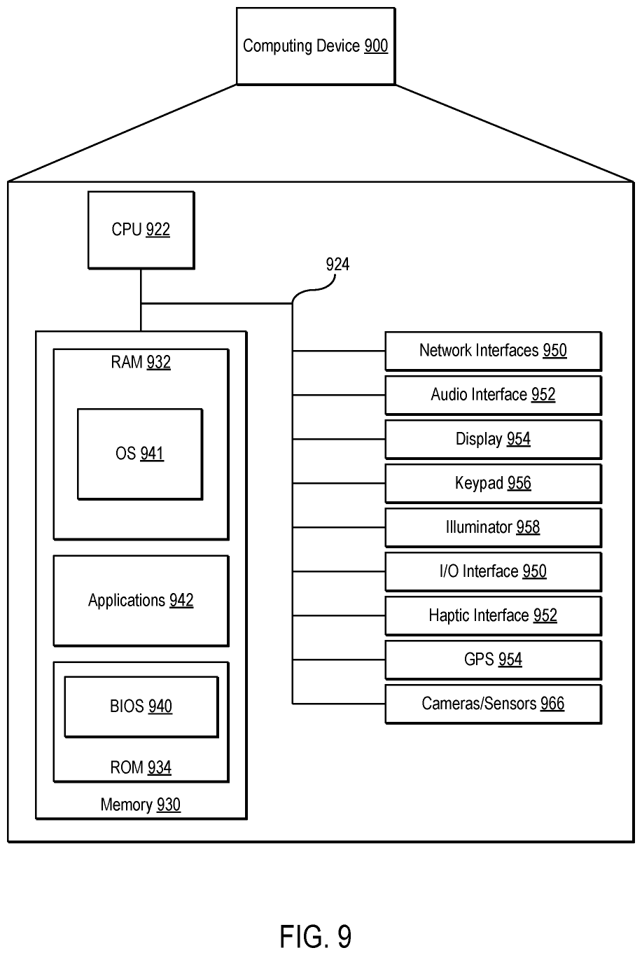

The firmware generator 102 can comprise a computing system or platform (such as that depicted in FIG. 9) capable of generating a firmware image 112. The firmware generator 102 can process firmware source 108 to generate such an image. For instance, the firmware generator 102 can compile the firmware source 108 using a compiler 110 to generate the firmware image 112. As such, the firmware image 112 can represent a compiled version of the firmware executable by a memory device 106. No limit is placed on the form of the firmware source 108 and any executable code and/or data can be included in the firmware source 108. Further, no limit is placed on the type of compiler technology used by compiler 110. As one example, the firmware source 108 may include code written in the C programming language as well as data or strings used by the firmware. The compiler 110 may comprise a standard C compiler such as GCC or LLVM that can generate an object form of the firmware source 108 (i.e., firmware image 112). In general, the firmware source 108 may be periodically generated based on the needs of any device. For example, the firmware source 108 can be released periodically as an update or patch. In some implementations, firmware image 112 can include both compiled data as well as plaintext data. Reference is made to FIG. 2 for an example of the contents of a firmware image.

In current systems, a firmware provider will provide the firmware image 112 to memory devices in the clear. Thus, if the firmware image 112 is obtained by an unauthorized or unintended party, such a party may reverse engineer the firmware image 112 to read potentially sensitive data (as discussed in FIG. 2). Further, in some systems, the firmware image 112 may be provided to third parties intentionally for patches or other fixes, thus may be readable by such parties.

As one option, the firmware image 112 may be encrypted using a strong encryption algorithm. For example, an Advanced Encryption Standard-Galois/Counter Mode (AES-GCM) encryption algorithm may be used which is a mode of operation for symmetric key cryptographic block ciphers that has been widely adopted due to its efficiency and performance. It combines the Galois/Counter Mode (GCM) with the Advanced Encryption Standard (AES). GCM provides authenticated encryption, which means it both encrypts data and produces an authentication tag, making sure that any modifications made to the ciphertext are detected. AES-GCM it is a robust and widely used mechanism to encrypt data but due to the complexity of operations is usually implemented via hardware. Indeed, many devices require a dedicated hardware circuit to encrypt/decrypt firmware images using AES-GCM. Similarly, using a software implementation of an AES-GSM implementation implies a high CPU time and a large lot of code footprint. Other encryption algorithms that provide sufficient security suffer from these problems as well.

Using a dedicated encryption routine is thus infeasible in many memory devices, especially in production devices that cannot be “re-engineered” to include decryption hardware. Further, the software implementations of such algorithms are not feasible on many memory devices. To remedy this problem, the system re-uses existing hardware that is present on many, if not all, memory devices: scrambler and descrambler circuits or algorithms.

Specifically, the firmware generator 102 includes a firmware manager 114 that can transmit the firmware image 112 to an emulation platform 104. The firmware manager 114 may be a locally running application that can connect to the emulation platform 104 and upload the firmware image 112 to the emulation platform 104.

In general, the emulation platform 104 can be a hardware emulation platform designed for the verification of digital circuits including memory device 106. It allows users and devices to run simulations of digital circuits and compare the simulated behavior to the expected behavior, to ensure that the circuit is functioning correctly. In some implementations, emulation platform 104 uses programmable logic devices (PLDs) to implement the digital circuits being simulated. These PLDs can be programmed to mimic the behavior of various types of digital logic gates, flip-flops, and other components, allowing users to create a faithful emulation of the target circuit. One of the advantages of emulation is that it allows users to test the functionality of a circuit at a high level of abstraction, without having to worry about the details of the underlying hardware implementation. This can be especially useful in the early stages of design, when the actual hardware may not yet be available or may not have been fully characterized. Further, the emulation platform 104 may be updated in sync with memory devices in production and may be capable of emulating multiple types of memory devices.

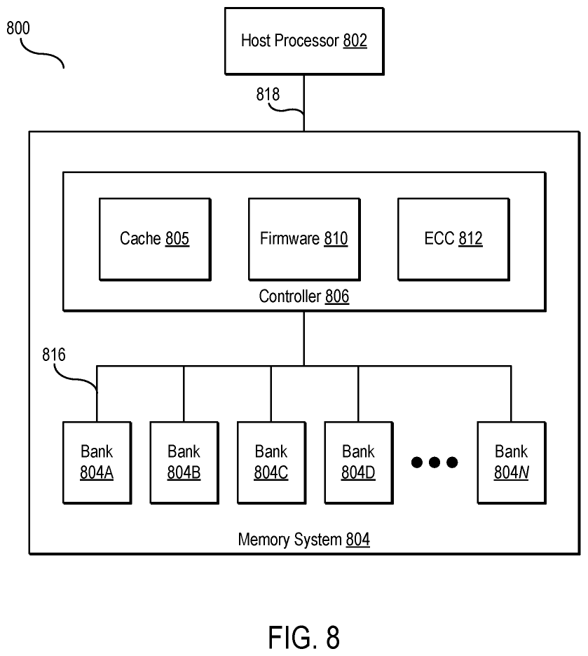

The emulation platform 104 may include various components not illustrated in FIG. 1 for the sake of brevity. In general, the emulation platform 104 includes an application programming interface (API 116) that can receive a firmware image 112 from a firmware generator 102. The API 116 may be implemented as a web server or other network server that can receive the firmware image 112. In some implementations, the API 116 will also receive a type of the memory device to emulate from the firmware generator 102. In response, the emulation platform 104 can load an emulated device 118. In some implementations, the emulated device 118 can be a software or PLD-implemented version of an actual memory device. While the emulated device 118 may include many components (e.g., such as those depicted in FIG. 8), FIG. 1 only illustrates a scrambler 120 included in the emulated device 118.

In general, a scrambler is a circuit or algorithm that is used to randomly rearrange or permute the bits of a digital signal in a NAND flash storage device. This is typically done to reduce the amount of DC bias in the signal and to improve its overall signal-to-noise ratio (SNR). In a NAND flash device, a scrambler will scramble data within a page and across a block and time. Without scrambling, NAND Flash devices have a tendency to lose data when programming the same pattern in the same block. Thus, a scrambler aids in randomizing content of the block to reduce wear leveling. In general, a scrambler uses a seed value to randomize cleartext data.

Conversely, and as depicted in memory device 106, a descrambler is a circuit or algorithm that is used to reverse the process of scrambling, so that the original signal can be recovered. In a NAND flash storage device, the descrambler is used to recover the original data from the scrambled signal that was written to the device. Both the scrambler and descrambler are used in NAND flash storage devices to help improve the reliability and performance of the device. They are often used in combination with error correction codes (ECCs) to help detect and correct errors that may occur during the read or write process.

In some implementations, the scrambler 120 may be a low-density parity check (LDPC) scrambler. An LDPC scrambler is a type of scrambler that uses low-density parity-check (LDPC) codes to scramble a digital signal. LDPC codes are a type of error correction code that are widely used in a variety of applications, including data storage and transmission. They are known for their ability to effectively detect and correct errors in digital signals and are often used in combination with scramblers to improve the reliability and performance of systems that transmit or store digital data. In an LDPC scrambler, the digital signal is first scrambled using a randomly generated permutation, and then an LDPC code is applied to the scrambled signal to add additional error detection and correction capabilities. The scrambled and LDPC-coded signal is then transmitted or stored, and the LDPC code is used to detect and correct any errors that may occur during transmission or storage. When the signal is received or read back from storage, it is descrambled and the LDPC code is used to correct any remaining errors. LDPC scramblers are often used in systems where reliable data transmission or storage is important, such as in communication systems or in NAND flash storage devices. They can help improve the reliability and performance of these systems by reducing the number of errors that occur during transmission or storage and by making it easier to detect and correct these errors.

In an implementation, the scrambler 120 may comprise a linear function that produces a balanced number of ones and zeros in a resultant output whose ratio will approximately 50:50 given an input pattern. In some implementations, the linear function can be based on a non-cryptographic hash function, such as a Fowler-Noll-Vo (FNV) hash function. In some implementations, this hash function can take inputs of various lengths and return a fixed length (e.g., 16-bit scrambling sequence) as an output. In the various embodiments described herein, scrambler 120 may be implemented using any similar operation that generates a random pattern given an input and a seed value.

In an implementation, the API 116 can forward the firmware image 112 to the scrambler 120 and the scrambler 120 can generate a scrambled firmware image 122. As illustrated in FIG. 3, this scrambled firmware image 122 sufficiently obscures the data of the firmware image 112 and thus prevents unauthorized access to the firmware image 112. Further, the use of a scrambler 120 results in a scrambled firmware image 122 that can be descrambled by existing hardware of a memory device 106 (e.g., descrambler 126). The scrambler 120 is additionally faster to operate than an encryption algorithm such as AES-GCM.

In some implementations, the emulation platform 104 can provide the scrambled firmware image 122 directly to the memory device 106. However, in other implementations, the emulation platform 104 may return the scrambled firmware image 122 to the firmware generator 102 via the API 116. In turn, the firmware generator 102 may provide the scrambled firmware image 122 to the memory device 106 via standard delivery mechanisms and techniques (e.g., push updates, providing on a website, etc.).

In the illustrated implementation, a memory device 106 can include an interface 124 in which to receive firmware images (including scrambled firmware image 122). In some implementations, this interface 124 may be a standardized interface (e.g., Joint Electron Device Engineering Council, JEDEC) interface supporting commands (e.g., field firmware update, FFU) for updating the firmware of the memory device 106. In response, the controller (executing current firmware) can descramble the scrambled firmware image 122 using a descrambler 126 local on the device. As discussed previously, this descrambler 126 may execute a counterpart algorithm to that used by scrambler 120 of emulation platform 104. In some implementations, the descrambler 126 may be implemented in either hardware, software, or firmware of the memory device 106. As a result, the descrambler 126 generates a descrambled firmware image which will be identical to the firmware image 112. Then, the memory device 106 can proceed to update the current firmware with firmware image 112 by, for example, overwriting the current firmware stored in storage area 128 with the firmware image 112 using any standard update procedure.

FIG. 2 is a block diagram of a sample firmware image.

As illustrated, a firmware image 200 may include various types of data. Critically, in current implementations, this data is transmitted in the clear. That is, while the data may be binary data (e.g., not human-readable), it is not encrypted or otherwise obfuscated in any manner. Thus, a malicious user that obtains a firmware image can reverse engineer the structure of the binary data to obtain the data depicted in FIG. 2. Further, in some implementations, the firmware image 200 may also include plaintext data (e.g., string data) that is easily extracted with minimal reverse engineering.

Some examples of data in the firmware image 200 include a password 204, keys 206 (e.g., hash-based message authentication, HMAC, keys), special strings 208, object code 210, and overlay data 212.

In some implementations, the password 204 may be a hard-coded password that is included in the underlying firmware source code. For example, the source code of the firmware may include the line ‘const char*pass=“password”;’. During compilation, the string literal may be retained within the compiled firmware image and thus can be reverse engineered from the binary object code.

In some implementations, the keys 206 may include various cryptographic keys used in operations of the memory device. For example, the keys 206 may include a storage key (e.g., used to encrypt data stored in the memory device) and/or an authentication key (e.g., used for authenticating access requests). The keys 206 may also include various other cryptographic keys such as an encryption/decryption key, a signing key, and/or a verification key. In some implementations, each of these cryptographic keys may be associated with one or more security domains, which specify different levels of access control over the protected resources. For example, the storage key may be associated with a first security domain that allows read-only access to the protected resources while the authentication key is associated with a second security domain that allows both read and write operations on the protected resources. In some implementations, the keys 206 may also include HMAC keys or similar types of keys.

In some implementations, the special strings 208 may include string literal values used by the memory device. These special strings 208 may be compiled as part of the firmware source code or may be included in plaintext along with the compiled code (e.g., as metadata). Examples of such special strings include a signature key, controller version, memory (e.g., NAND) type identifier, firmware name, firmware version, firmware build number, firmware build or release date, etc.

In some implementations, the object code 210 may include the compiled and executable firmware instructions. In some implementations, the object code 210 may include a set of dynamically linked library (DLL) files or shared object (SO) files.

In some implementations, overlay data 212 refers to a set of instructions or data that is written to a specific location in the NAND flash memory and is intended to modify the behavior of the firmware or device. Overlay data 212 can be used for a variety of purposes, such as adding new features or functionality to the device, fixing bugs or security vulnerabilities, or modifying the behavior of the device in some other way. One common use for overlay data 212 in NAND flash firmware is to allow for flexible and dynamic updating of the device's firmware without requiring a full firmware update. For example, an overlay might be used to add a new feature to the device without requiring the user to perform a full firmware update, or to fix a bug or security vulnerability without requiring the user to install a new version of the firmware. Overlay data 212 can be implemented in a number of different ways, depending on the specific requirements of the device and the firmware. They may be stored as separate files that are loaded and executed by the firmware at runtime, or they may be incorporated directly into the firmware code itself. In either case, the use of overlays allows for more flexible and dynamic updating of the firmware and can help to improve the overall stability and security of the device.

FIG. 3 is a diagram illustrating different encryption techniques as applied to a firmware image.

In a first example, an XOR cipher 302 is applied to binary data 306 to generated cipher binary data 308. In an implementation, XOR cipher 302 is a type of symmetric key cipher, which means that the same key is used for both encryption and decryption. It works by combining the binary data 306 with a key (not illustrated) using the Boolean XOR operation to generate cipher binary data 308. To decrypt the message, the key is XORed with the ciphertext again to produce the original plaintext. One of the advantages of an XOR cipher is that it is very simple to implement and requires only a single Boolean operation. However, it is also relatively easy to break, as the key can be easily recovered by XORing two known plaintext-ciphertext pairs. Further, as illustrated, structural components of the binary data can still be observed. In the binary data 306, the end of meaningful data is filled with hex values “cc” until the end of the data. In the cipher binary data 308, this end of data can still be detected since the value of “cc” is simply converted to “99” and repeated until the end of the file.

By contrast, FIG. 3 also illustrates the use of a scrambler 304 that introduces randomness in the binary data 306 to generate scrambled binary data 310. As illustrated, the scrambled binary data 310 include random values at all positions, preventing reverse engineering of the structure of the input data. Various details of scrambler 304 are provided previously and not repeated herein.

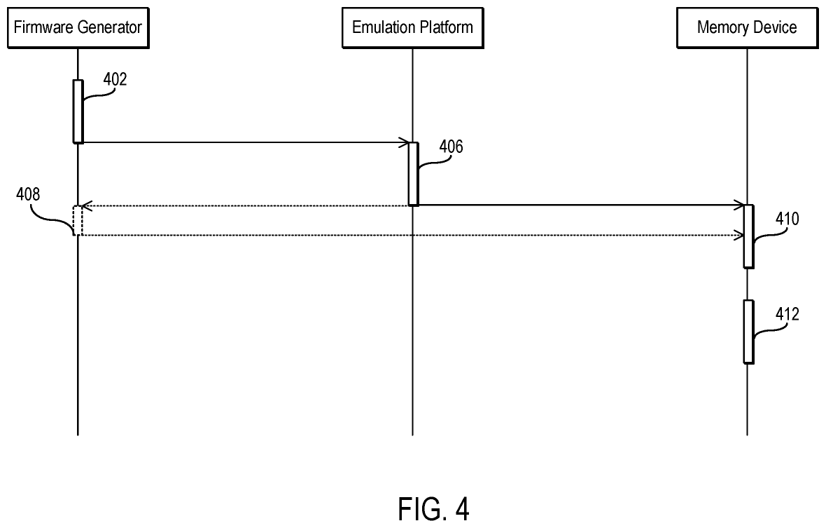

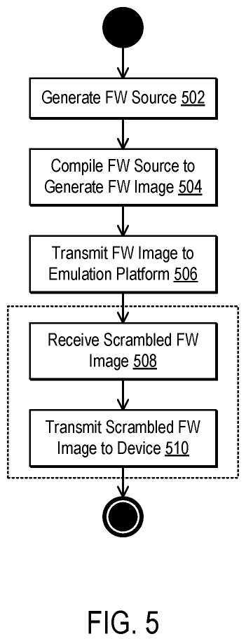

FIG. 4 is a swimlane diagram illustrating a method for delivering firmware to memory devices. Various details of the operations of the firmware generator, emulation platform, and memory device are described more fully in FIGS. 5, 6, and 7, respectively and those details are not included here.

In step 402, a firmware generator can generate a firmware image by executing a script (e.g., a Python® or similar script) which can compile or otherwise assemble firmware source code into a firmware image and transmit the firmware image to an emulation platform. Details of step 402 are provided in FIG. 5.

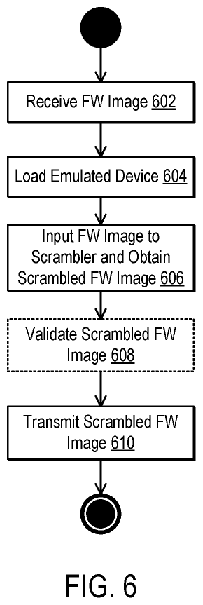

In step 406, the emulation platform can scramble the firmware image. As illustrated, in a first implementation, the emulation platform may then transmit the scrambled firmware image to one or more memory devices. Alternatively, or in conjunction with the foregoing, the emulation platform can transmit the scrambled firmware image to back to the firmware generator. Details of steps 406 are provided in FIGS. 5 and 6.

In step 408, if the emulation platform returns the scrambled firmware image to the firmware generator, the firmware generator can prepare and send the scrambled firmware image to the one or more memory devices. Details of step 408 are provided in FIG. 6.

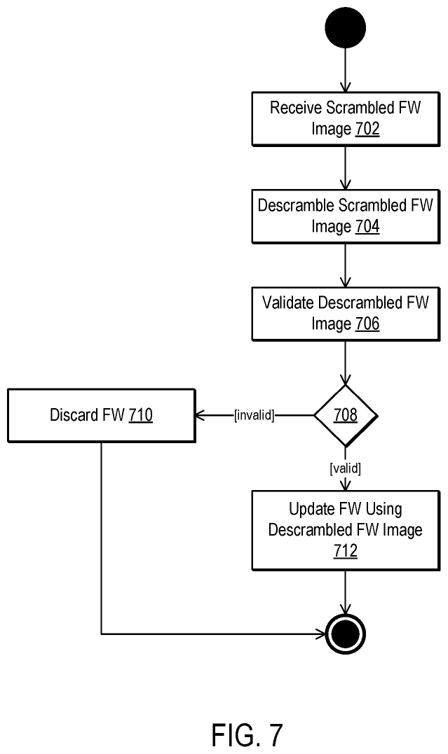

In step 410, the memory device receives the scrambled firmware image and descrambles the firmware image. In step 412, the memory device installs the descrambled firmware image. Details of step 408 are provided in FIG. 7.

FIG. 5 is a flow diagram illustrating a method for generating and securing a firmware image.

In step 502, the method can include generating firmware source. In some implementations, the firmware source can include various types of data such as those described in FIG. 2. For example, the firmware source can include source code (e.g., code implemented in C or C++). Additionally, the firmware source can include various items of non-executable data or metadata used by the memory device when installing and/or running the firmware. For example, key or password data can be included in the firmware source.

In step 504, the method can include compiling the firmware source to generate a firmware image. In some implementations, step 504 can include using a compiler, assembler, linker, or similar software tools to obtain a binary image of the firmware. In some implementations, this binary image will include the compiled object code as well as sensitive data that may be stored in the clear. For example, as described in FIG. 2, the binary image can include keys, passwords, special strings, and the like which are compiled in the binary image but accessible when viewing the underlying hexadecimal/binary code. As such, any user with the appropriate and easily accessible tools can open the binary file and extract such data.

In step 506, the method can include transmitting the firmware image to an emulation platform. In an implementation, the firmware image may be generated on a workstation or network of computing devices. Such a device may include a network interface to allow the device to connect to the emulation platform. In such implementations, the device can upload the firmware image to the emulation platform. In some implementations, the emulation platform may expose an API or similar endpoint allowing for uploads. In some implementations, these uploads may be programmatically triggered or may be manually uploaded. In some implementations, the method can include generating a digital signature using the firmware image and including this signature when transmitting the firmware image to the emulation platform. In some implementations, the signature can be generated using a key management server (KMS) private key or by another trusted entity that a downstream memory device holds the public key for.

In step 508, the method can include receiving a scrambled firmware image.

In some implementations, the endpoint provided by the emulation platform may be capable of returning data in response to a firmware image upload. For example, if the emulation platform provides a Hypertext Transfer Protocol (HTTP) endpoint, the emulation platform can be configured to return an HTTP response to an HTTP POST message that includes the firmware image. In such an implementation, the emulation platform may return a scrambled version of the firmware image to the device that uploaded the firmware image.

In step 510, the method can include transmitting the scrambled firmware image to a memory device.

In some implementations, the same device that generated the firmware image can transmit the scrambled firmware image to the memory device. In other implementations, the device that generates the firmware image can forward the scrambled firmware image to an additional device (e.g., firmware server) that manages firmware versions. In some implementations, this additional device can comprise a well-known endpoint that distributes firmware to memory devices. For example, the additional device can comprise trusted server that memory devices query for firmware updates. In this manner, a memory device may continue to query an established update server to obtain scrambled firmware images according to standard practices.

As illustrated, step 508 and step 510 may be optional. If optional, the emulation platform may transmit the scrambled firmware image to a memory device. Alternatively, the emulation platform may transmit the scrambled firmware image to the additional device (e.g., update server) as discussed above.

FIG. 6 is a flow diagram illustrating a method for scrambling a firmware image.

In step 602, the method can include receiving a firmware image. As discussed previously, the firmware image received in step 602 may comprise a clear binary image that includes potentially sensitive data. In some implementations, the method can also operate on non-binary data. In some implementations, the method can receive the firmware image over a network via an API implemented on, for example, an application or web server. In other implementations, the method can receive the firmware image via an inter-process communication (IPC) message from an application running local to the method.

In step 604, the method can include loading an emulated device.

In some implementations, an emulation platform can emulate multiple types of memory devices and each emulated device can be stored accordingly. In some implementations, the firmware image received in step 602 can be associated with a specific type of memory device (e.g., by model number, part number, etc.). For example, an HTTP request can include the firmware image and one or more query parameters that define which device the firmware targets. In some implementations, the method can identify the emulated device by extracting the memory device identifier from the firmware image itself. In some implementations, the request including the firmware image can specify multiple memory devices. In such implementations, the method can repeat the following steps for each memory device. As such, in these implementations, the method can generate multiple scrambled firmware images.

Once the method identifies the emulated device, the method can instantiate the emulated device in memory. In some implementations, the emulated device can be executed similar to a virtual machine or container and can emulate the physical functions of the underlying memory device. In some implementations, the emulated device may expose multiple functions to enable testing of emulated sub-components of a memory device. Thus, while a physical memory device may provide a limited input/output interface, the emulated device may provide the ability to test and access internal components of the memory device, including internal circuits or modules of a controller. One such circuit or module includes the scrambler and descrambler modules discussed in FIG. 1.

In step 606, the method can include inputting the firmware image into a scrambler associated with the emulated device.

As discussed, the emulated device may expose a scrambler input via a defined interface. As such, the method can input the binary firmware image into the scrambler to obtain a scrambled firmware image. In some implementations, the method can use a sliding window approach based on the input size of the scrambler to scramble the entire firmware image. For example, the scrambler may support up to four kilobytes of input data. As such, the method can segment the firmware image into four kilobyte chunks and input these chunks sequentially into the scrambler to obtain scrambled chunks. The method can then reassemble the scrambled chunks to obtain the scrambled firmware image.

In some implementations, the scrambler may utilize a seed value to randomize the input data. In a first implementation, a fixed seed value may be used for each scramble operation. In other implementations, the seed value may be changed each time a scramble operation is performed. For example, if a sixteen-kilobyte image is segmented into four, four kilobyte chunks, four separate seed values may be used to scramble the respective chunks. In some implementations, these seed values may be random. Alternatively, the seed values can be initially random and then incremented for each operation. In some implementations, the method can store the seed values used with the firmware image for descrambling.

In step 608, the method can include validating the scrambled firmware image. In some implementations, step 608 may be optional.

As discussed above, in some implementations, the emulated device can expose various internal components of a memory device, including a descrambler. As such, in step 608, the method can attempt to descramble the scrambled firmware image generated in step 606. If seed values are varied, these seed values can be used to descramble the scrambled firmware image. Since the descrambler in the emulated device is consistent with the physical descrambler, step 608 can act as a check to ensure that a deployed memory device will be capable of successfully descrambling the scrambled firmware image. In some implementations, step 608 can be implemented as a sequential step. In other implementations, step 608 can be executed at any time and an alert can be issued if the descrambling fails. Given that the scrambling and descrambling operations are significantly faster than encryption and decryption operations, they may be performed as part of the deployment process to validate the images.

In step 610, the method can include transmitting the scrambled firmware image to a preconfigured endpoint.

As discussed above, step 610 may include transmitting the scrambled firmware image to one or more destinations. As a first example, the method can transmit the scrambled firmware back to the device that transmitted the firmware image received in step 602. In this manner, the method acts as a scramble function as a service for the calling party. As a second example, the method can transmit the scrambled firmware to a designated computing device. In some implementations, this designated computing device may comprise an update server that is responsible for managing and pushing firmware updates to memory devices. As a third example, the method can push a firmware update directly to one or more memory devices as identified by the method during step 604. Notably, in any example, the security of the channel is not required as the scrambled firmware image is not easily reverse engineered by malicious parties. In some implementations, the method can include forwarding a received digital signature to the endpoint.

FIG. 7 is a flow diagram illustrating a method for installing a scrambled firmware image.

In step 702, the method can include receiving a scrambled firmware image. In some implementations, the method can be implemented by a controller of a memory device. In some implementations, the controller can receive a command to update the firmware of the memory device, the command including the scrambled firmware. In some implementations, the command can comprise a standard command such as a JEDEC FFU command to update the memory device's firmware.

In step 704, the method can include descrambling the scrambled firmware image to obtain descrambled firmware image. In some implementations, a controller of memory device that receives the scrambled firmware image can input the scrambled firmware image into a descrambler circuit onboard the memory device. In some implementations, this descrambler circuit comprises a physical counterpart to the scrambler module used by an emulation platform to generate the scrambled firmware image. In another implementation, the descrambler can comprise a software-implemented descrambler. In either implementation, the descrambler may comprise a LDPC descrambler.

In step 706, the method can include validating the descrambled firmware image. In some implementations, when receiving the scrambled firmware image, the method may also receive a digital signature generated using the descrambled firmware image (discussed previously) and can validate the descrambled firmware image using the digital signature using known digital signature algorithms. Similarly various error corrections can be performed to ensure that the descrambled firmware image is valid.

In step 708, the method can include determining if the descrambled firmware is valid. As discussed, in some implementations, the method can compare the digital signature to an expected value computed using the descrambled firmware using existing digital signature algorithms to validate the descrambled firmware image.

In step 710, the method can include discarding the firmware if the validation in step 708 fails. In some implementations, if the method cannot validate the descrambled firmware, it will discard the firmware and raise an error in response to the command to update the firmware, preventing corrupted firmware from being installed. In some implementations, step 710 can also include determining if the descrambling operation was successful. If either the descrambling operation was unsuccessful or the descrambled firmware image is invalid, method will terminate.

In step 712, the method can include updating the current firmware using the descrambled firmware image if the validation in step 708 succeeds. In some implementations, the method can include writing the descrambled firmware to a designated location in the storage area of a memory device such that on reboot the memory device will use the descrambled firmware in lieu of the current firmware. In some implementations, the method can back up the current firmware for potentially rolling back as needed.

FIG. 8 is a block diagram illustrating a memory system according to some embodiments of the disclosure.

As illustrated in FIG. 8, a computing system 800 includes a host processor 802 communicatively coupled to a memory system 804 via a bus 818. The memory system 804 comprises a controller 806 communicatively coupled to one or more memory banks 804A-804N, forming a memory array via an interface 816. As illustrated, controller 806 includes a local cache 805, firmware 810, and an error correction code (ECC) module 812.

In the illustrated embodiment, a host processor 802 can comprise any type of computer processor, e.g., a central processing unit (CPU), graphics processing unit (GPU), or other types of general-purpose or special-purpose computing devices. The host processor 802 includes one or more output ports that allow for the transmission of address, user, and control data between the host processor 802 and the memory system 804. In the illustrated embodiment, this communication is performed over the bus 818. In one embodiment, the bus 818 comprises an input/output (I/O) bus or a similar type of bus.

The memory system 804 is responsible for managing one or more memory banks 804A-804N. In one embodiment, the banks 804A-804N comprise NAND Flash dies or other configurations of non-volatile memory. In one embodiment, the memory banks 804A-804N comprise a memory array.

The banks 804A-804N are managed by the controller 806. In some embodiments, controller 806 comprises a computing device configured to mediate access to and from banks 804A-804N. In one embodiment, controller 806 comprises an ASIC or other circuitry installed on a printed circuit board housing the banks 804A-804N. In some embodiments, the controller 806 may be physically separate from the banks 804A-804N. Controller 806 communicates with the banks 804A-804N over interface 816. In some embodiments, this interface 816 comprises a physically wired (e.g., traced) interface. In other embodiments, the interface 816 comprises a standard bus for communicating with banks 804A-804N.

Controller 806 comprises various modules 805-812. In one embodiment, the various modules 805-812 comprise various physically distinct modules or circuits. In other embodiments, the modules 805-812 may completely (or partially) be implemented in software or firmware.

As illustrated, firmware 810 comprises the core of the controller and manages all operations of the controller 806. Firmware 810 may implement some or all the methods described above.

FIG. 9 is a block diagram illustrating a computing device showing an example of a client or server device used in the various embodiments of the disclosure.

The computing device 900 can include more or fewer components than those shown in FIG. 9, depending on the deployment or usage of the device 900. For example, a server computing device, such as a rack-mounted server, may not include audio interfaces 952, displays 954, keypads 956, illuminators 958, haptic interfaces 962, Global Positioning Service (GPS) receivers 964, or cameras/sensors 966. Some devices can include additional components not shown, such as graphics processing unit (GPU) devices, cryptographic co-processors, artificial intelligence (AI) accelerators, or other peripheral devices.

As shown in the FIG. 9, device 900 includes a central processing unit (CPU) 922 in communication with a mass memory 930 via a bus 924. The computing device 900 also includes one or more network interfaces 950, an audio interface 952, a display 954, a keypad 956, an illuminator 958, an input/output interface 960, a haptic interface 962, an optional global positioning systems (GPS) receiver 964 and a camera(s) or other optical, thermal, or electromagnetic sensors 966. Device 900 can include one camera/sensor 966 or a plurality of cameras/sensor 966. The positioning of the camera(s)/sensor(s) 966 on the device 900 can change per device 900 model, per device 900 capabilities, and the like, or some combination thereof.

In some embodiments, the CPU 922 can comprise a general-purpose CPU. The CPU 922 can comprise a single-core or multiple-core CPU. The CPU 922 can comprise a system-on-A-chip (SoC) or a similar embedded system. In some embodiments, a GPU can be used in place of, or in combination with, a CPU 922. Mass memory 930 can comprise a dynamic random-access memory (DRAM) device, a static random-access memory device (SRAM), or a Flash (e.g., NAND Flash) memory device. In some embodiments, mass memory 930 can comprise a combination of such memory types. In one embodiment, the bus 924 can comprise a Peripheral Component Interconnect Express (PCIe) bus. In some embodiments, the bus 924 can comprise multiple buses instead of a single bus.

Mass memory 930 illustrates another example of computer storage media for the storage of information such as computer-readable instructions, data structures, program modules, or other data. Mass memory 930 stores a basic input/output system (“BIOS”) 940 for controlling the low-level operation of the computing device 900. In the illustrated embodiment, the BIOS 940 may be stored in a read-only memory (ROM) such as ROM 934. The mass memory also stores an operating system 941 for controlling the operation of the computing device 900

Applications 942 can include computer-executable instructions which, when executed by the computing device 900, perform any of the methods (or portions of the methods) described previously in the description of the preceding figures. In some embodiments, the software or programs implementing the method embodiments can be read from a hard disk drive (not illustrated) and temporarily stored in RAM 932 by CPU 922. CPU 922 can then read the software or data from RAM 932, process them, and store them in RAM 932 again.

The computing device 900 can optionally communicate with a base station (not shown) or directly with another computing device. Network interface 950 is sometimes known as a transceiver, transceiving device, or network interface card (NIC).

The audio interface 952 produces and receives audio signals such as the sound of a human voice. For example, the audio interface 952 can be coupled to a speaker and microphone (not shown) to enable telecommunication with others or generate an audio acknowledgment for some action. Display 954 can be a liquid crystal display (LCD), gas plasma, light-emitting diode (LED), or any other type of display used with a computing device. Display 954 can also include a touch-sensitive screen arranged to receive input from an object such as a stylus or a digit from a human hand.

Keypad 956 can comprise any input device arranged to receive input from a user. Illuminator 958 can provide a status indication or provide light.

The computing device 900 also comprises an input/output interface 960 for communicating with external devices, using communication technologies, such as USB, infrared, Bluetooth®, or the like. The haptic interface 962 provides tactile feedback to a user of the client device.

The optional GPS receiver 964 can determine the physical coordinates of the computing device 900 on the surface of the Earth, which typically outputs a location as latitude and longitude values. GPS receiver 964 can also employ other geo-positioning mechanisms, including, but not limited to, triangulation, assisted GPS (AGPS), E-OTD, CI, SAI, ETA, BSS, or the like, to further determine the physical location of the computing device 900 on the surface of the Earth. In one embodiment, however, the computing device 900 can communicate through other components, providing other information that can be employed to determine the physical location of the device, including, for example, a MAC address, IP address, or the like.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to the desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product or software that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as read-only memory (“ROM”), random access memory (“RAM”), magnetic disk storage media, optical storage media, flash memory components, etc.

In this description, various functions and operations are described as being performed by or caused by computer instructions to simplify the description. However, those skilled in the art will recognize what is meant by such expressions is that the functions result from the execution of the computer instructions by one or more controllers or processors, such as a microprocessor. Alternatively, or in combination, the functions and operations can be implemented using special-purpose circuitry, with or without software instructions, such as using Application-Specific Integrated Circuit (ASIC) or Field-Programmable Gate Array (FPGA). Embodiments can be implemented using hardwired circuitry without software instructions or in combination with software instructions. Thus, the techniques are limited neither to any specific combination of hardware circuitry and software nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

We claim:

1. A system comprising:
a firmware generator;
a memory device; and
an emulation platform, the emulation platform configured to:
receive a firmware image from the firmware generator,
scramble the firmware image using a scrambler module to obtain a scrambled firmware image, and
transmit the scrambled firmware image to the memory device.

2. The system of claim 1, wherein the memory device is configured to:
receive the scrambled firmware image;
descramble the scrambled firmware image using a descrambler circuit to obtain a descrambled firmware image; and
install the descrambled firmware image.

3. The system of claim 1, wherein the emulation platform is further configured to load an emulated memory device corresponding to the memory device.

4. The system of claim 3, wherein the scrambler module comprises an emulated scrambler circuit corresponding to a physical descrambler circuit of the memory device.

5. The system of claim 1, wherein the emulation platform is further configured to validate the scrambled firmware image using an emulated descrambler module.

6. The system of claim 1, wherein the emulation platform is configured to transmit the scrambled firmware image to the memory device by transmitting the scrambled firmware image to an update server.

7. The system of claim 1, wherein the emulation platform is configured to transmit the scrambled firmware image to the memory device by transmitting the scrambled firmware image to the firmware generator.

8. The system of claim 1, wherein the scrambler module comprises a low-density parity check (LDPC) scrambler.

9. A method comprising:
receiving a firmware image;
scrambling the firmware image using an emulated scrambler to generate a scrambled firmware image; and
transmitting the scrambled firmware image to at least one memory device.

10. The method of claim 9, wherein scrambling the firmware image using an emulated scrambler comprises scrambling the firmware image comprises scrambling the firmware image using a low-density parity check (LDPC) scrambler.

11. The method of claim 9, wherein receiving the firmware image comprises identifying an identify of the at least one memory device and loading a corresponding emulated memory device that includes the emulated scrambler.

12. The method of claim 11, wherein identifying an identify of the at least one memory device comprises extracting an identify of the at least one memory device from the firmware image.

13. The method of claim 9, further comprising validating the scrambled firmware image by descrambling the scrambled firmware image using an emulated descrambler.

14. The method of claim 9, wherein transmitting the scrambled firmware image to at least one memory device comprising transmit the scrambled firmware image to the at least one memory device by transmitting the scrambled firmware image to an update server.

15. The method of claim 9, wherein the firmware image comprises a binary image, the binary image including one of a password, key, special string, or overlay data.

16. A memory device comprising:
a storage area configured for storing firmware images; and
a controller configured to:
receive a scrambled firmware image,
descramble the scrambled firmware image to obtain a descrambled firmware image, and
install the descrambled firmware image in the storage area.

17. The memory device of claim 16, wherein the controller is configured to descramble the scrambled firmware image by inputting the scrambled firmware image to a descrambler circuit.

18. The memory device of claim 17, wherein the descrambler circuit comprises a low-density parity check (LDPC) descrambler.

19. The memory device of claim 16, wherein the controller is further configured to validate the descrambled firmware image prior to installing the descrambled firmware image.

20. The memory device of claim 16, wherein the controller is configured to receive the scrambled firmware image via a firmware update command.
